(19) United States
(12) Patent Application Publication
(10) Pub. No.: US 2007/0020463 A1
(43) Pub. Date: Jan. 25, 2007

(54) FLEXIBLE POLYMER COATING AND COATED FLEXIBLE SUBSTRATES

(76) Inventor: James A. Trainham, Sewickley, PA (US)

Correspondence Address: PPG INDUSTRIES INC;INTELLECTUAL PROPERTY DEPT, ONE PPG PLACE, PITTSBURGH, PA, 15272, US

(21) Appl. No.: 11/461,844

(22) Filed: Aug. 2, 2006

Related U.S. Application Data
(63) Continuation-in-part of application No. 11/172,718, filed on Jul. 1, 2005.
(63) Continuation-in-part of application No. 11/021,325, filed on Dec. 23, 2004.
(63) Continuation-in-part of application No. 11/020,906, filed on Dec. 23, 2004.

(51) Int. Cl. B32B 27/40

(52) U.S. Cl. 428/423.1

(57) ABSTRACT

A coated flexible substrate comprising a flexible substrate, and a coating deposited on at least a portion of the substrate, is disclosed. The coating is generally flexible. Coated textiles are also disclosed.

### CROSS REFERENCE TO RELATED APPLICATIONS

This application is a continuation-in-part of U.S. application Ser. No. 11/172,718 filed Jul. 1, 2005, U.S. application Ser. No. 11/021,325 filed Dec. 23, 2004, and U.S. application Ser. No. 11/020,906 filed Dec. 23, 2004, which are all incorporated herein by reference.

### FIELD OF THE INVENTION

The present invention relates generally to coated flexible substrates, such as textiles.

### BACKGROUND OF THE INVENTION

Many substrates, such as textiles, thermoplastic urethane, ethylene vinyl acetate foam and leather, have a significant amount of flexibility. It is often desirable to coat these substrates with a coating to improve appearance, water resistance, chemical resistance, scratch resistance, ultraviolet resistance and durability. It may also be desired to coat or otherwise “decorate” these substrates to provide an improved appearance, apply a pattern, and the like. Many coatings that improve these properties are rigid coatings suitable for use on rigid substrates. When a rigid coating, such as an acrylic coating, is applied to a flexible substrate, the coating will often crack and peel away from the substrate when the substrate is flexed. Accordingly, a flexible coating suitable for use on flexible substrates is desired.

### SUMMARY OF THE INVENTION

The present invention is directed to a coated flexible substrate, comprising a flexible substrate, and a coating deposited on at least a portion of the substrate, wherein the coating comprises a first component comprising (i) a first polyester polyol having a first functionality and (ii) a second polyester polyol having a second functionality, wherein the second functionality is greater than the first functionality; and a second component comprising an isocyanate, wherein the coating has an NCO:OH ratio of 1:1 or greater; wherein the flexible substrate comprises a textile.

The present invention is further directed to a coated flexible substrate comprising a flexible substrate, and a coating deposited on at least a portion of the substrate, wherein the coating comprises an aqueous polyurethane resin having a hydroxyl number of less than 10 and a colorant.

The present invention is further directed to a coated flexible substrate comprising a flexible substrate, and a coating deposited on at least a portion of the substrate, wherein the coating comprises the reaction product of an acid functional polyurethane dispersion and a crosslinker, wherein the acid functional polyurethane dispersion comprises an active hydrogen-containing polyether having a weight average molecular weight of greater than or equal to 2000, dimethylolpropionic acid, a polyisocyanate, and a chain extender, wherein at least 70 percent of the acid functionality is neutralized.

### DETAILED DESCRIPTION

The present invention is directed to a coated flexible substrate comprising a flexible substrate and a coating deposited on at least a portion of the substrate. In certain embodiments, the coating comprises a two component or “2K” solvent-based polymer coating composition. The first component comprises a first polyester polyol having a first functionality and a second polyester polyol having a second functionality, wherein the second functionality is greater than the first functionality. “Functionality” refers to the number of hydroxyl groups per molecule of the polyol. “Polyol” refers to polyol and/or polyol composition. The second component comprises an isocyanate. The NCO:OH ratio of the coating composition is 1:1 or greater. “NCO:OH ratio” refers to the ratio of isocyanate groups to hydroxyl groups in the coating composition. It will be appreciated that the two components, when combined, produce a polyurethane coating.

In one embodiment, the difference between the hydroxyl numbers of the first polyester polyol and the second polyester polyol is at least 10. In another embodiment, the difference between the hydroxyl numbers of the first polyester polyol and the second polyester polyol is at least 20. In one embodiment, the first polyester polyol of the first component has a low functionality. As used herein, the term “low functionality” and like terms mean that the polyester polyol has a hydroxyl number of less than 65, such as less than 60. A suitable low functionality polyester polyol has a hydroxyl number of from 40 to 60. In one embodiment, the first polyester polyol has a hydroxyl number of from 54 to 58. The low functionality of the first polyester polyol results in increased flexibility and a lower tendency to form crosslinks when reacted with an isocyanate in a coating. Any polyester polyol having a low functionality can be used in the present invention. For example, the first polyester polyol can be the reaction product of a carboxylic acid and polyalcohol; such products are commercially available from Bayer Corporation in their DESMOPHEN line, from Degussa in their DYNAPOL line, from Eastman as POLYMAC 1935 and ALBESTER 6325 and from Synthopol Chemie as SYNTHOESTER 1170.

In one embodiment, the second polyester polyol of the first component has a medium functionality. As used herein, the term “medium functionality” and like terms mean that the polyester polyol has a hydroxyl number of from 90 to 125. In one embodiment, the second polyester polyol has a hydroxyl number of from 104 to 118. The medium functionality of the second polyester polyol typically increases the crosslink density of the coating, resulting in increased coating hardness and improved chemical resistance. Any polyester polyol having medium functionality can be used in the present invention. For example, the second polyester polyol can be the reaction product of a polyol, an aromatic dicarboxylic acid and/or anhydride, and/or an aliphatic dicarboxylic acid and/or anhydride. The second polyester polyol can be the reaction product of isophthalic acid, phthalic anhydride, adipic acid, trimethylol propane, and 1,6 hexanediol; such products are commercially available from Bayer Corporation in their DESMOPHEN line, from Degussa in their DYNAPOL line, Eastman in their POLYMAC line and REACTOL PE 125, and from Synthopol in their SYNTHOESTER line. In certain embodiments, either one or both of the polyester polyols specifically exclude neopentyl glycol.

The first and second polyester polyols can be combined together to form a polyester polyol blend in the first component. In one embodiment, the ratio of the first polyester polyol to the second polyester polyol in the polyester polyol blend is from 5:1 to 8:1. In another embodiment, the ratio of the first polyester polyol to the second polyester polyol in the polyester polyol blend is from 6.5:1 to 7.5:1. The amount of the first polyester polyol and the amount of the second polyester polyol in the blend can be selected to optimize certain features of each polyol. For example, an increased amount of the first polyester polyol results in increased flexibility, while an increased amount of the second polyester polyol results in increased hardness and chemical resistance. One skilled in the art can determine the best ratio based upon these considerations depending on the needs of the user.

In one embodiment, the first polyester polyol, the second polyester polyol and an acrylic polyol can be combined to produce a first component. An acrylic polyol can be added to the polyester polyol blend in the first component in order to further increase the strength of the coating. In one embodiment, the acrylic polyol is a styrenated acrylic polyol. Examples of other suitable acrylic polyols include copolymers of methyl (meth)acrylate with hydroxy functional (meth)acrylate monomers, copolymers of isobornyl (meth)acrylate, ethyl (meth)acrylate copolymers, hydroxyl-ethyl (meth)acrylate, and hydroxyl-propyl methacrylate. The acrylic polyols can have functionality or be substantially non-functional. In one embodiment, acrylic polyols used in the present invention can have a hydroxyl number of at least 50. In one embodiment, acrylic polyols, such as styrenated acrylic polyols, can be added to the first component in an amount up to 70 weight percent.

The acrylic polyols can be provided in any amount desired to provide sufficient strength to the coating. The acrylic polyols will typically crosslink with isocyanate in the final coating, thereby increasing the crosslink density and hardness of the coating. Since increased amounts of acrylic polyol may increase the strength of the coating, but decrease the amount of flexibility, the desired amount of acrylic polyol must be determined based upon the needs of the user.

The second component of the two-component coating of certain embodiments comprises an isocyanate. As used herein, the term “isocyanate” and like terms include isocyanate, polyisocyanates, and cyclic trimers of polyisocyanates. Suitable isocyanates include isophorone diisocyanate, 1,3- or 1,4-cyclohexane diisocyanate, dicyclohexylmethane diisocyanate, tetraalkylxyene diisocyanates such as m-tetramethyl xylene diisocyanate, p-phenylene diisocyanate, polymethylene polyphenyl isocyanate, diphenylmethylene diisocyanate, 2,6-toluene diisocyanate, dianisdine diisocyanate, bitolylene diisocyanate, naphthalene-1,4-diisocyanate, bis(4-isocyanato phenyl)methane, 4,4′-diphenylpropane diisocyanate, hexamethylene diisocyanate, and, where appropriate, trimers thereof, such as an isocyanate trimer of hexamethylene diisocyanate.

The amount of polyester polyol blend, and acrylic polyol if used, in the first component and the amount of isocyanate in the second component can be selected such that the ratio of isocyanate groups to hydroxyl groups, i.e. NCO:OH, will produce a coating composition having an NCO:OH ratio of 1:1 or greater. “Greater than 1:1”, “1:1 or greater”, and like terms mean that the NCO component will be higher than the OH component. In certain embodiments, the NCO:OH ratio is greater than 1:1. In certain embodiments, the NCO:OH ratio is at least 1.2:1, such as greater than 1.2:1. In certain embodiments, the NCO:OH ratio is at least 1.4:1, such as greater than 1.4:1. In certain embodiments, the NCO:OH ratio is 1.7:1 or greater, such as 2:1 or greater. In general, the NCO:OH ratio can be 3:1 or lower, such as 2.5:1 or lower. It is surprising that the coatings used in certain embodiments of the present invention, such as those having an NCO:OH ratio of greater than 1.2:1, exhibit improved flexibility. Conventional teachings indicate that coatings having higher NCO:OH ratios exhibit increased rigidity. In traditional polyurethane compositions, excess isocyanate groups (NCO groups) typically form side reactions with available amines, water and/or alcohols, and become rigid. Accordingly, it is surprising that a coating having a relatively high NCO:OH ratio as compared to traditional coatings has improved flexibility. It is further surprising that coatings used according to certain embodiments of the present invention wherein the NCO:OH ratio is 1.2:1 or greater, such as 1.4:1 or greater, may have a Young's modulus and/or tensile strength typical for coatings having a lower NCO:OH ratio.

In certain other embodiments of the present invention, the coating comprises an aqueous polyurethane resin having a hydroxyl number of less than 10 and a colorant.

In certain embodiments of the present invention, the coating comprising the aqueous polyurethane resin is substantially solvent-free. The term “substantially solvent-free” as used herein means that the coating composition contains less than about 15 or 20 weight percent organic solvents, preferably less than 5 or 10 weight percent, with weight percent being based on the total weight of the coating composition to be applied to the substrate. For example, the coating composition may contain from zero to 2 or 3 weight percent organic solvents.

The term “aqueous” as used herein means coating compositions in which the carrier fluid of the composition is predominantly water on a weight percent basis, i.e., more than 50 weight percent of the carrier comprises water. The remainder of the carrier comprises less than 50 weight percent organic solvent, typically less than 25 weight percent, preferably less than 15 weight percent. Based on the total weight of the coating composition (including the carrier and solids), the water may comprise from about 20 to about 80 weight percent, typically from about 30 to about 70 weight percent, of the total composition.

The coatings used according to the present invention can comprise a polyurethane dispersion. Any polyurethane resin that forms a suitable film, and is compatible with aqueous compositions, can be used in accordance with the present invention, absent compatibility problems. Suitable polyurethane resins include those formed from a polyisocyanate, an active hydrogen-containing material, such as a polyol, a polyether, a polyester, a polycarbonate, a polyamide, a polyurethane, a polyurea, a polyamine, a polyolefin, a siloxane polyol, and/or mixtures thereof, an acid functional material having a functional group reactive with isocyanate and optionally a polyamine. Examples of acid functional materials include dimethyl propionic acid and butanoic acid. Some example resins that may be suitable for use in the present coating compositions are described in U.S. Pat. No. 5,939,491, which is incorporated by reference herein.

In one non-limiting embodiment, the polyurethane has a molecular weight average of at least 10,000, such as at least 25,000, such as 100,000 or higher. The polyurethane resin in certain embodiments has a hydroxyl number of less than about 10, such as less than about 5, such as less than about 3. The film-forming polyurethane resin is generally present in the coating in an amount greater than about 20 weight percent, such as greater than about 40 weight percent, and less than 90 weight percent, with weight percent being based on the total solid weight of the cured coating. For example, the weight percent of resin can be between 20 and 80 weight percent.

In one non-limiting embodiment, di and/or trifunctional acrylics, polyesters, polyethers, polycarbonates, polyamides, epoxies and/or vinyls can be added as a partial replacement for a portion of the polyurethane dispersion. Suitable di and/or trifunctional acrylic resins can include unsaturated acrylic monomers and/or copolymers with vinyl monomers prepared through emulsion polymerization. Suitable polyester resins can include reaction products of polyfunctional acid anhydrides, polyfunctional alcohols and monofunctional acids and alcohols. Other suitable resins include hybrids or mixtures of any of these resins, for example, acrylic/polyurethane and/or acrylic/polyester hybrids and/or blends.

In certain other embodiments, the coating comprises the reaction product of an acid functional polyurethane dispersion and a crosslinker, wherein the acid functional polyurethane dispersion comprises an active-hydrogen containing polyether having a weight average molecular weight of greater than or equal to 2000, dimethylolpropionic acid, a polyisocyanate, and a chain extender, and wherein at least 70 percent of the acid functionality is neutralized. “Polyurethane” as used herein includes polyurethanes, polyureas, and mixtures thereof.

The coating used according to these embodiments of the present invention imparts a “soft feel” to the substrate. The term “soft feel” will be understood as giving a velvet-like or leather-like feel to an otherwise hard substrate.

The soft-feel coating used according to certain embodiments of the present invention comprises the reaction product of an acid functional polyurethane dispersion and a crosslinker. The polyurethane dispersion comprises an active hydrogen-containing polyether having a weight average molecular weight of greater than or equal to 2000. Suitable polyethers include those having an active hydrogen-containing group that is reactive with isocyanate. Examples include but are not limited to hydroxyl groups and amine groups. Nonlimiting examples of suitable active hydrogen-containing materials comprise polyols, polyethers, polyesters, polycarbonates, polyamides, polyurethanes, polyureas, polyamines, polyolefins, siloxane polyols, and mixtures thereof. In certain embodiments, the active hydrogen-containing material does not include acid functional groups. For example, the active hydrogen-containing polyether can be polytetramethylene ether glycol; such as that commercially available from Invista, Inc. as TERETHANE 2000. Other examples of suitable active hydrogen-containing materials are disclosed in U.S. Ser. No. 11/020,906, the contents of which are hereby incorporated by reference.

Generally, the amount of active hydrogen-containing material that is used to prepare the polyurethane can be up to 70 weight percent, and may be in the range of 10 to 25 percent by weight based on total weight of the resin solids used to make the polyurethane component.

The polyurethane dispersion used in certain embodiments of the present invention further comprises dimethylolpropionic acid. “Dimethylolpropionic acid” includes substituted dimethylolpropionic acid. The dimethyl propionic acid can be incorporated into the polymer without the use of pyrrolidones or other water-compatible, high boiling point solvents. Certain embodiments therefore specifically exclude such solvents, such as pyrrolidone and/or N-methyl pyrrolidone.

The amount of dimethylolpropionic acid that is used to prepare the polyurethane is at least 1 percent, typically ranging from at least 1 to 20 percent, and in some embodiments ranging from 6 to 10 percent by weight based on total weight of the resin solids used to form the polyurethane.

The acid functional polyurethane further comprises a polyisocyanate. Suitable polyisocyanates used for preparing the polyurethane component can include aliphatic, cycloaliphatic, araliphatic, and aromatic isocyanates, and mixtures thereof.

Examples of suitable aliphatic and cycloaliphatic polyisocyanates include 4,4-methylenebisdicyclohexyl diisocyanate (hydrogenated MDI), hexamethylene diisocyanate (HDI), isophorone diisocyanate (IPDI), methylenebis(cyclohexyl isocyanate), trimethyl hexamethylene diisocyanate (TMDI), meta-tetramethylxylylene diisocyanate (TMXDI), and cyclohexylene diisocyanate (hydrogenated XDI). Other aliphatic polyisocyanates include isocyanurates of IPDI and HDI.

Examples of suitable aromatic polyisocyanates include tolylene diisocyanate (TDI) (i.e., 2,4-tolylene diisocyanate, 2,6-tolylene diisocyanate or a mixture thereof), diphenylmethane-4,4-diisocyanate (MDI), naphthalene-1,5-diisocyanate (NDI), 3,3-dimethyl-4,4-biphenylene diisocyanate (TODI), crude TDI (i.e., a mixture of TDI and an oligomer thereof), polymethylenepolyphenyl polyisocyanate, crude MDI (i.e., a mixture of MDI and an oligomer thereof), xylylene diisocyanate (XDI) and phenylene diisocyanate.

Polyisocyanate derivatives prepared from hexamethylene diisocyanate, 1-isocyanato-3,3,5-trimethyl-5-isocyanatomethylcyclohexane (“IPDI”), including isocyanurates thereof, and/or 4,4′-bis(isocyanatocyclohexyl)methane are also suitable.

The amount of polyisocyanate used to prepare the polyurethane component generally ranges from 15 to 50 percent by weight, and may range from 20 to 35 percent by weight based on total weight of the resin solids used to prepare the polyurethane component.

It will be appreciated that the acid functionality of the polyurethane dispersion derives from the dimethylolpropionic acid. At least about 70 percent of the acid functionality on the polyurethane dispersion can be neutralized. In certain embodiments, such as when a longer pot life is desired, the percent neutralization can be near 100 percent, such as at least 90 percent. In other embodiments, excess neutralizing agent can be added. Any appropriate neutralizing agent can be used. Examples include, but are not limited to, inorganic and organic bases such as sodium hydroxide, potassium hydroxide, ammonia, amines, alcohol amines having at least one primary, secondary, or tertiary amino group and at least one hydroxyl group. Suitable amines include alkanolamines such as monoethanolamine, diethanolamine, dimethylaminoethanol, diisopropanolamine, and the like. It will be further appreciated that the neutralizing agent forms a salt with the acid functionality on the polyurethane. The salt acts somewhat like a blocking agent in that it interferes with the reaction between the acid functionality and the crosslinker. This gives the uncured coating composition used in the present invention an excellent “pot life”. That is, the pot life of the uncured coating composition can range from 1 to 6 months. As noted above, there is a correlation between the amount of neutralization and the pot life. When the coating is deposited onto the substrate and/or heat is added, the neutralizing agent volatizes, leaving the acid functionality that is free to react with the crosslinker thus curing the coating.

The polyurethane further includes a chain extender, such as for example, a polyamine. Useful polyamines include primary or secondary diamines or polyamines in which the groups attached to the nitrogen atoms can be saturated or unsaturated, aliphatic, alicyclic, aromatic, aromatic-substituted-aliphatic, aliphatic-substituted-aromatic and heterocyclic. Exemplary suitable aliphatic and alicyclic diamines include 1,2-ethylene diamine, 1,2-propylene diamine, 1,8-octane diamine, isophorone diamine, propane-2,2-cyclohexyl amine, adipic acid dihydrazide, 2-amino ethyl ethanolamine, and the like. Suitable aromatic diamines include phenylene diamines and the toluene diamines, for example, o-phenylene diamine and p-tolylene diamine. These and other suitable polyamines are described in detail in U.S. Pat. No. 4,046,729 at column 6, line 61 to column 7, line 26, incorporated herein by reference. Based upon the total weight of resin solids from which the polyurethane component is formed, the amount of chain extender can range from 1 to 8 weight percent, and in some embodiments can range from 2.5 to 5 weight percent.

Any suitable crosslinker can be used. Particularly suitable are carbodiimide or aziridine crosslinkers. In certain embodiments, combinations of crosslinkers can be used. In other embodiments, only one crosslinker, such as carbodiimide or aziridine, is used.

The ratio of crosslinker to acid functionality can vary depending on the needs of the user. For example, the ratio can range from 0.1-1.5:1, such as 0.5:1.

In certain embodiments of the present invention, these coatings are substantially solvent-free. “Substantially solvent-free” is defined above.

In certain embodiments of the present invention, these coatings are aqueous. The term “aqueous” is also defined above.

The polyurethane dispersion and crosslinker are generally present in the coating in an amount greater than 20 weight percent, such as greater than 40 weight percent and less than 90 weight percent, with weight percent being based on the total solid weight of the cured coating. For example, the weight percent of polyurethane dispersion and crosslinker can be between 20 and 80 weight percent.

Various additives can be added to any of the coatings used in accordance with the present invention. For 2K coatings, these additives added are typically to the first component, but could be added to either or both components based upon the needs of the user. Examples of suitable additives include solvents such as acetates, alcohols, ketones, glycols, ethers, aliphatics, cycloaliphatics and aromatics. Examples of acetates include ethyl acetate, butyl acetate, and glycol acetate. Examples of ketones include methyl ethyl ketone and methyl-N-amyl ketone. Examples of aromatics are toluene, naphthalene and xylene. In one embodiment, one or more solvents are added to each of the first component and the second component. Suitable solvent blends can include, for example, one or more acetates, propanol and its derivatives, one or more ketones, one or more alcohols and/or one or more aromatics.

Other suitable additives include texture-enhancing additives such as silica or a paraffin wax to improve the surface feel of the coating and to enhance stain resistance. Other suitable additives can include those standard in the art, including but not limited to plasticizers, viscosity modifers, leveling agents, adhesion promoters, colorants, rheology modifiers, ultra-violet (UV) absorbers, and hindered amine light stabilizers (HALS). A suitable viscosity modifer is cellulose acetate butyrate. Suitable UV absorbers include those sold by Ciba in its TINUVIN line, such as 328 and 292. A suitable catalyst includes dibutyl tin dilaurate. Suitable suspension agents include BENTONE products, such as BENTONE 34, commercially available from Elementis Specialties and AEROSIL products, such as AEROSIL 200, commercially available from Degussa. A suitable flow control additive includes BAYSILONE 067, commercially available from Bayer Corporation.

The coatings of the present invention can also include a colorant. As used herein, the term “colorant” means any substance that imparts color and/or other opacity and/or other visual effect to the composition. The colorant can be added to the coating in any suitable form, such as discrete particles, dispersions, solutions and/or flakes. A single colorant or a mixture of two or more colorants can be used in the coatings of the present invention.

Example colorants include pigments, dyes and tints, such as those used in the paint industry and/or listed in the Dry Color Manufacturers Association (DCMA), as well as special effect compositions. A colorant may include, for example, a finely divided solid powder that is insoluble but wettable under the conditions of use. A colorant can be organic or inorganic and can be agglomerated or non-agglomerated. Colorants can be incorporated into the coatings by use of a grind vehicle, such as an acrylic grind vehicle, the use of which will be familiar to one skilled in the art.

Example pigments and/or pigment compositions include, but are not limited to, carbazole dioxazine crude pigment, azo, monoazo, disazo, naphthol AS, salt type (lakes), benzimidazolone, condensation, metal complex, isoindolinone, isoindoline and polycyclic phthalocyanine, quinacridone, perylene, perinone, diketopyrrolo pyrrole, thioindigo, anthraquinone, indanthrone, anthrapyrimidine, flavanthrone, pyranthrone, anthanthrone, dioxazine, triarylcarbonium, quinophthalone pigments, diketo pyrrolo pyrrole red (“DPPBO red”), titanium dioxide, carbon black and mixtures thereof. The terms “pigment” and “colored filler” can be used interchangeably.

Example dyes include, but are not limited to, those that are solvent and/or aqueous based such as pthalo green or blue, iron oxide, bismuth vanadate, anthraquinone, perylene, aluminum and quinacridone.

Example tints include, but are not limited to, pigments dispersed in water-based or water miscible carriers such as AQUA-CHEM 896 commercially available from Degussa, Inc., CHARISMA COLORANTS and MAXITONER INDUSTRIAL COLORANTS commercially available from Accurate Dispersions division of Eastman Chemical, Inc.

As noted above, the colorant can be in the form of a dispersion including, but not limited to, a nanoparticle dispersion. Nanoparticle dispersions can include one or more highly dispersed nanoparticle colorants and/or colorant particles that produce a desired visible color and/or opacity and/or visual effect. Nanoparticle dispersions can include colorants such as pigments or dyes having a particle size of less than 150 nm, such as less than 70 nm, or less than 30 nm. Nanoparticles can be produced by milling stock organic or inorganic pigments with grinding media having a particle size of less than 0.5 mm. Example nanoparticle dispersions and methods for making them are identified in U.S. Pat. No. 6,875,800 B2, which is incorporated herein by reference. Nanoparticle dispersions can also be produced by crystallization, precipitation, gas phase condensation, and chemical attrition (i.e., partial dissolution). In order to minimize re-agglomeration of nanoparticles within the coating, a dispersion of resin-coated nanoparticles can be used. As used herein, a “dispersion of resin-coated nanoparticles” refers to a continuous phase in which is dispersed discreet “composite microparticles” that comprise a nanoparticle and a resin coating on the nanoparticle. Example dispersions of resin-coated nanoparticles and methods for making them are identified in U.S. Patent Application Publication 2005-0287348 A1, filed Jun. 24, 2004, U.S. Provisional Application No. 60/482,167 filed Jun. 24, 2003, and U.S. patent application Ser. No. 11/337,062, filed Jan. 20, 2006, which is also incorporated herein by reference.

Example special effect compositions that may be used in the coating of the present invention include pigments and/or compositions that produce one or more appearance effects such as reflectance, pearlescence, metallic sheen, phosphorescence, fluorescence, photochromism, photosensitivity, thermochromism, goniochromism and/or color-change. Additional special effect compositions can provide other perceptible properties, such as opacity or texture. In a non-limiting embodiment, special effect compositions can produce a color shift, such that the color of the coating changes when the coating is viewed at different angles. Example color effect compositions are identified in U.S. Pat. No. 6,894,086, incorporated herein by reference. Additional color effect compositions can include transparent coated mica and/or synthetic mica, coated silica, coated alumina, a transparent liquid crystal pigment, a liquid crystal coating, and/or any composition wherein interference results from a refractive index differential within the material and not because of the refractive index differential between the surface of the material and the air.

In certain non-limiting embodiments, a photosensitive composition and/or photochromic composition, which reversibly alters its color when exposed to one or more light sources, can be used in the coating of the present invention. Photochromic and/or photosensitive compositions can be activated by exposure to radiation of a specified wavelength. When the composition becomes excited, the molecular structure is changed and the altered structure exhibits a new color that is different from the original color of the composition. When the exposure to radiation is removed, the photochromic and/or photosensitive composition can return to a state of rest, in which the original color of the composition returns. In one non-limiting embodiment, the photochromic and/or photosensitive composition can be colorless in a non-excited state and exhibit a color in an excited state. Full color-change can appear within milliseconds to several minutes, such as from 20 seconds to 60 seconds. Example photochromic and/or photosensitive compositions include photochromic dyes.

In a non-limiting embodiment, the photosensitive composition and/or photochromic composition can be associated with and/or at least partially bound to, such as by covalent bonding, a polymer and/or polymeric materials of a polymerizable component. In contrast to some coatings in which the photosensitive composition may migrate out of the coating and crystallize into the substrate, the photosensitive composition and/or photochromic composition associated with and/or at least partially bound to a polymer and/or polymerizable component in accordance with a non-limiting embodiment of the present invention, have minimal migration out of the coating. Example photosensitive compositions and/or photochromic compositions and methods for making them are identified in U.S. application Ser. No. 10/892,919 filed Jul. 16, 2004 and incorporated herein by reference.

In general, the colorant can be present in the coating composition in any amount sufficient to impart the desired visual and/or color effect. The colorant may comprise from 1 to 65 weight percent of the present compositions, such as from 3 to 40 weight percent or 5 to 35 weight percent, with weight percent based on the total weight of the compositions.

As used herein, the term “coating” means a material that forms a substantially continuous layer or film on a substrate. Coatings can be applied to flexible substrates, including but not limited to textiles, in any desired thickness, such as a thickness suitable to achieve a desired mechanical and/or visual effect. In one non-limiting embodiment, the coatings may seep into a portion of the surface of the flexible substrate while maintaining a coating on the exterior surface of the flexible substrate. In certain embodiments the exterior surface of the flexible substrate is coated. By “exterior surface” is meant a surface that is exposed upon assembly of the flexible substrate into a finished product. Examples related to the use of textiles include the exterior surface of an article of clothing or the exterior surface of a floor covering.

The coating compositions used according to the present invention are suitable for producing any type of coating, and are particularly suitable as topcoats on substrates. In one embodiment, the coatings of the present invention can be used as a single application coating or monocoat. In another embodiment, the coating can be used as one or more of a multiple layer coating in which each coat may contain the same or different additives. The coatings of the present invention can be used alone or in combination with other coatings. In certain embodiments, it may be desirable to use an adhesion promoter layer on the substrate to be coated. In certain embodiments it may be desired to apply to the substrate one or more coatings described above in a design or pattern. Such designs and/or patterns can use one color, or two or more colors of the coatings described above. In certain embodiments it may be desired to apply one or more coatings to substantially all of the substrate. In this manner, a color or colors can be imparted to the substrate.

The coating compositions used according to the present invention can be applied to flexible substrates, including textiles, in any known manner such as brushing, spraying, rolling, roll coating, slot coating and/or dipping. The coatings can also be applied by any known manner of dying, printing, or coloring, such as silk-screening, ink-jet printing, jet dying, jet injection dying, transfer printing and the like. Such methods can be computer controlled, as will be understood by one skilled in the art, and may involve pixel-wise application of color to a substrate such as is discussed in U.S. Pat. Nos. 6,792,329 and 6,854,146, both of which are incorporated by reference in their entirety. A “pixel” is the smallest area or location in a pattern or on a substrate that can be individually assignable or addressable with a given color. For example, such methods can be used to print a pattern and/or color onto a substrate; a “pattern” on a substrate can mean that the substrate has been colored, such as on a pixel-by-pixel basis, by application of a colorant to the substrate, typically in a predetermined manner. In the various methods for dying, printing or otherwise imparting color to a substrate, computers and digital design software can be used to develop a digital design that is fed to a digitally controlled dying, printing or coloring apparatus; such apparatus are commercially available and can be used in accordance with the manufacturers' instructions.

The curing of these coatings can comprise a flash at ambient or elevated temperatures followed by a thermal bake in order to obtain optimum properties. The coatings of the present invention are typically deposited on the flexible substrate to a thickness of from 0.1 to 3 mils. In one embodiment, the coating is deposited to a thickness of from 0.5 to 1.0 mils.

As used herein, the term “flexible substrate” refers to a substrate that can undergo mechanical stresses, such as bending or stretching and the like, without significant irreversible change. In certain embodiments, the flexible substrates are compressible substrates. “Compressible substrate” and like terms refer to a substrate capable of undergoing a compressive deformation and returning to substantially the same shape once the compressive deformation has ceased. The term “compressive deformation” and like terms mean a mechanical stress that reduces the volume at least temporarily of a substrate in at least one direction. Examples of flexible substrates includes non-rigid substrates, such as woven and nonwoven fiberglass, woven and nonwoven glass, woven and nonwoven polyester, thermoplastic urethane (TPU), synthetic leather, natural leather, finished natural leather, finished synthetic leather, foam, polymeric bladders filled with air, liquid, and/or plasma, urethane elastomers, synthetic textiles and natural textiles. “Foam” can be a polymeric or natural material comprising open cell foam and/or closed cell foam. “Open cell foam” means that the foam comprises a plurality of interconnected air chambers; “closed cell foam” means that the foam comprises discrete closed pores. Example foams include but are not limited to polystyrene foams, polyvinyl acetate and/or copolymers, polyvinyl chloride and/or copolymers, poly(meth)acrylimide foams, polyvinylchloride foams, polyurethane foams, and polyolefinic foams and polyolefin blends. Polyolefinic foams include but are not limited to polypropylene foams, polyethylene foams and ethylene vinyl acetate (“EVA”) foams. EVA foam can include flat sheets or slabs or molded EVA foams, such as shoe midsoles. Different types of EVA foam can have different types of surface porosity. Molded EVA can comprise a dense surface or “skin”, whereas flat sheets or slabs can exhibit a porous surface. “Textiles” can include natural and/or synthetic textiles such as fabric, vinyl and urethane coated fabrics, mesh, netting, cord, yarn and the like, and can be comprised, for example, of canvas, cotton, polyester, KELVAR, polymer fibers, polyamides such as nylons and the like, polyesters such as polyethylene terephthalate and polybutylene terephthalate and the like, polyolefins such as polyethylene and polypropylene and the like, rayon, polyvinyl polymers such as polyacrylonitrile and the like, other fiber materials, cellulosics materials and the like.

The flexible coatings of the present invention have a wide variety of applications. For example, the flexible substrate can be incorporated into and/or form part of sporting equipment, such as athletic shoes, balls, bags, clothing and the like; apparel; automotive interior components; motorcycle components; household furnishings such as decorative pieces and furniture upholstery; wallcoverings such as wallpaper, wall hangings, and the like; floor coverings such as rugs, runners, area rugs, floor mats, vinyl and other flooring, carpets, carpet tiles and the like.

Coatings of the present invention exhibit flexibility such that they are suitable for application onto flexible substrates. The present coatings do not readily crack when the substrates are manually flexed. Another benefit of the coatings of the present invention is that the coatings do not crack or peel when restrained in a flexed position for an extended period of time, such as up to three months.

In certain embodiments of the invention, the coatings described herein have an elongation to break of at least 50 percent, such as least 100 percent. In one embodiment, the coating has an NCO:OH ratio of 1.4:1 and an elongation to break of 140% or greater. In one embodiment of the invention, a flexible substrate coated with a coating of the present invention has an elongation to break of at least 197 percent. As used herein, the term “elongation to break” means the percent strain in the tensile mode at the point at which specimen failure is observed. Higher elongation to break indicates more elongation of the specimen. Elongation to break can be determined, for example, using an Instron Mini 44 Unit equipped with a 50N load cell.

As used herein, unless otherwise expressly specified, all numbers such as those expressing values, ranges, amounts or percentages may be read as if prefaced by the word “about”, even if the term does not expressly appear. Any numerical range recited herein is intended to include all sub-ranges subsumed therein. Plural encompasses singular and vice versa. Thus, while reference is made throughout the specification to “a” polyol, “an” isocyanate, “a” solvent, “a” carboxylic acid and/or anhydride, “a” polyalcohol, “a” flexible substrate, “a” textile, “a” coating, “a” colorant, etc., combinations of such components can be used. Also, as used herein, the term “polymer” is meant to refer to oligomers and both homopolymers and copolymers, the prefix “poly” refers to two or more.

### EXAMPLE

The following example is intended to illustrate the invention and should not be construed as limiting the invention in any way. Coatings according to the present invention can hypothetically be prepared as follows:

A two component coating can be prepared by preparing a first component and a second component, and mixing the two components prior to application. To form a first component, two polyester polyols can be mixed, such as at low speed using a rotary stirrer at ambient temperature. The two polyols can be, for example, those listed herein. The two polyols can be used in any ratio described herein. Various additives, such as catalyst(s), colorant(s), suspending agent(s), UV absorber(s), and/or solvent(s), can be added with stirring. The additive(s)/solvent(s) can be added all at once or sequentially, according to methods and practices known in the art. The components should be stirred for a time sufficient to assure full incorporation of components.

A second component can be prepared by mixing the desired isocyanate(s) with suitable solvent(s).

The first and second components can then be mixed for a period of time to assume complete incorporation. The two components should be used in appropriate amounts to give the desired NCO:OH ratio. One skilled in the art will appreciate that the amount or concentration of polyol in the first component and the amount or concentration of isocyanate in the second component will be used in determining the amount of each component to use to get the desired NCO:OH ratio. It may also be desired to adjust the viscosity of the coating using means standard in the art.

After complete mixing of the two components, the coating can be applied to the desired flexible substrate by any suitable means, such as spraying, using for example a Binks Model #7 gun at an atomized pressure of 60 to 70 psi and low fluid flow. The coating can be sprayed onto, for example, EVA foam, TPU laminate, leather, finished natural leather, vinyl (PVC) and/or TPU. The coating thickness can be as described herein, such as 0.6 mils +/−0.4 mils. The coating can then be cured by means standard in the art, such as a 10-minute flash at ambient temperature followed by a thermal bake at 180° for 30 minutes. The coated substrates may be further conditioned such as at 72° F. and ambient humidity for several days to insure a more complete cure.

Coated substrates, such as EVA foam, TPU laminate, TPU, finished natural leather, and vinyl (PVC) of the present invention can be expected to exhibit an initial adhesion of 5B, according to test method B of ASTM Standard D3359—lattice pattern cut through coating to substrate, pressure sensitive tape applied and quickly removed—with the numeric value representation adhesion measured on a scale of 0 to 5 with 5 being no delamination. Similar results (i.e. “5B”) can be expected with coated substrates tested after 24 hours in a humidity chamber of 100° F. and 100% relative humidity for 10 days. The coated substrates can be expected to have minimal or no cracking when tested seven days post-cure by manually bending the substrate 180 degrees.

Whereas particular embodiments of this invention has been described above for purposes of illustration, it will be evident to those skilled in the art that numerous variations of the details of the present invention may be made without departing from the invention as defined in the appended claims.

What is claimed is:

1. A coated flexible substrate, comprising:
a flexible substrate, and
a coating deposited on at least a portion of the substrate, wherein the coating comprises:
a) a first component comprising: (i) a first polyester polyol having a first functionality and (ii) a second polyester polyol having a second functionality, wherein the second functionality is greater than the first functionality; and
b) a second component comprising an isocyanate, wherein the coating has an NCO:OH ratio of 1:1 or greater; wherein the flexible substrate comprises a textile.

2. The coated flexible substrate of claim 1, wherein the difference between the hydroxyl number of the first polyester polyol and the hydroxyl number of the second polyester polyol is at least 10.

3. The coated flexible substrate of claim 1, wherein the difference between the hydroxyl number of the first polyester polyol and the hydroxyl number of the second polyester polyol is at least 20.

4. The coated flexible substrate of claim 1, wherein the first polyester polyol comprises the reaction product of a dicarboxylic acid and/or anhydride and a polyalcohol.

5. The coated flexible substrate of claim 1, wherein the second polyester polyol comprises the reaction product of a dicarboxylic acid and/or anhydride and a polyalcohol.

6. The coated flexible substrate of claim 1, wherein the second polyester polyol comprise a reaction production of isophthalic acid, phthalic anhydride, adipic acid, trimethylol propane, and 1,6 hexanediol.

7. The coated flexible substrate of claim 1, wherein the coating has an NCO:OH ratio of 1.2:1 or greater.

8. The coated flexible substrate of claim 1, wherein the coating has an NCO:OH ratio of 1.4:1 or greater.

9. The coated flexible substrate of claim 1, wherein the coating has an NCO:OH ratio of 1.7 or greater.

10. The coated flexible substrate of claim 1, wherein the textile is incorporated into a floor covering.

11. A coated flexible substrate, comprising:
a flexible substrate, and
a coating deposited on at least a portion of the substrate, wherein the coating comprises an aqueous polyurethane resin having a hydroxyl number of less than 10 and a colorant.

12. The coated flexible substrate of claim 11, wherein the hydroxyl number is less than 5.

13. The coated flexible substrate of claim 11, wherein the polyurethane has a molecular weight of at least 10,000.

14. The coated flexible substrate of claim 11, wherein the coating is substantially solvent-free.

15. The coated flexible substrate of claim 11, wherein the colorant comprises a nanoparticle dispersion.

16. The coated flexible substrate of claim 11, wherein the flexible substrate comprises a textile.

17. A coated flexible substrate, comprising:
a flexible substrate, and
a coating deposited on at least a portion of the substrate, wherein the coating comprises the reaction product of an acid functional polyurethane dispersion and a crosslinker, wherein the acid functional polyurethane dispersion comprises an active hydrogen-containing polyether having a weight average molecular weight of greater than or equal to 2000, dimethylolpropionic acid, a polyisocyanate, and a chain extender, wherein at least 70 percent of the acid functionality is neutralized.

18. The coated flexible substrate of claim 17, wherein the flexible substrate comprises a textile.

19. The coated flexible substrate of claim 18, wherein the textile is incorporated into a floor covering.

20. The coated flexible substrate of claim 17, wherein the coating comprises a colorant and the colorant comprises a nanoparticle dispersion.

21. The coated flexible substrate of claim 1, wherein the coating comprises a colorant and the colorant comprises a nanoparticle dispersion.

22. The coated flexible substrate of claim 16, wherein the textile is incorporated into a floor covering.
